(19) United States
(12) Patent Application Publication
(10) Pub. No.: US 2011/0154422 A1
(43) Pub. Date: Jun. 23, 2011

(54) SYSTEM AND METHOD FOR PROVIDING MULTI-TERMINAL CONTEXT-BASED CUSTOMIZED BROADCASTING SERVICE IN NETWORK

(75) Inventors: Jae-Chan SHIM, Daejeon-si (KR); Hwa-Suk KIM, Daejeon-si (KR); Kee-Seong CHO, Daejeon-si (KR)

(73) Assignee: Electronics and Telecommunications Research Institute, Daejeon-si (KR)

(21) Appl. No.: 12/899,090

(22) Filed: Oct. 6, 2010

(30) Foreign Application Priority Data
Dec. 18, 2009 (KR) 10-2009-0127295

(51) Int. Cl. H04N 7/173

(52) U.S. Cl. 725/109

(57) ABSTRACT

A system and method for providing a broadcasting service in a multi terminal context in an IP based network are provided. A subscriber of a customized convergence broadcasting service organizes a personal program log, and a broadcast server provides a broadcasting service to the subscriber according to the personal program log. In order for the subscriber to receive broadcasting services using various types of heterogeneous terminals, a service control server controls customized convergence broadcasting services according to information about the status of each terminal possessed by the subscriber and a degree of preference to a terminal preferred by the subscriber among the terminals.

### CROSS-REFERENCE TO RELATED APPLICATION

This application claims the benefit under 35 U.S.C. §119(a) of Korean Patent Application No. 10-2009-0127295, filed on Dec. 18, 2009, the disclosure of which is incorporated by reference in its entirety for all purposes.

### BACKGROUND

1. Field

The following description relates to a system and method for providing a broadcasting service, and more particularly, to a system for selectively providing a subscriber having a plurality of heterogeneous wired/wireless terminals in an IP network with a context-based convergence broadcasting service according to the status of the terminals possessed by the subscriber and the degree of preference of the subscriber for each terminal and a control method thereof.

2. Description of the Related Art

A technology for an IP based context-based customized broadcasting service has been mainly developed in two divisions. First, a method of receiving a broadcasting service is suggested in which a desired broadcast content is relocated at a desired time only using terrestrial/cable/satellite broadcasting contents conveyed through a network-personal video recorder (n-PVR) server or an IP network. Second, in order to enhance the above service, a method of supporting various types of contents, such as VoD and UCC, allowing user's selection for contents to be widened is suggested. Such a context-based customized broadcasting service is implemented only for a subscriber who receives an IP Set Top Box (STB) service accessible to a wired access network.

However, in a Broadband convergence Network (BcN) environment establishing a convergence of various types of wired/wireless access networks, if a subscriber possesses various heterogeneous wired/wireless terminals, and if a certain terminal has a restriction on receiving a context-based customized broadcasting service, the preference and satisfaction of subscribers to the service is lowered, thereby limiting the profit of the corresponding service provider.

### SUMMARY

In one aspect, there is provided a system and control method for selectively providing a subscriber having a plurality of heterogeneous wired/wireless terminals with a customized convergence broadcasting service in an IP network according to the status of terminals possessed by the subscriber and the preference of the subscriber to each terminal.

In another aspect, there is provided a system for providing a broadcasting system and a control method thereof, capable of determining a method of controlling services based on a function of periodically recognizing the status of wired/wireless terminals possessed by a subscriber and information about user's preference, such as the preference for each terminal regarding customized convergence broadcasting services, and thus controlling the customized convergence broadcasting service based on the determined service controlling method.

In one general aspect, there is provided a system for providing a broadcasting service in a multi-terminal context in an IP based network, the system includes a broadcast server, a terminal managing server and a service control server. The broadcast server is configured to provide a broadcasting service to a terminal of a subscriber according to a channel selected by the subscriber or by a subscriber program log personalized for the subscriber. The terminal managing server is configured to monitor each status of a plurality of terminals possessed by the subscriber and manage information about the status of each terminal. The service control server is configured to select a terminal suitable for receiving the broadcasting service by use of the information about the status of the each terminal and provide the selected terminal with the broadcasting service.

The broadcast server further includes a broadcasting service control unit configured to perform control such that the broadcast service is provided to the terminal selected by the service control server by communicating with the service control server.

The terminal managing server includes a terminal related information storage unit, a terminal status monitoring unit, a terminal status related information sending unit and a subscriber related information sending unit. The terminal related information storage unit is configured to store and manage information about the terminals possessed by the subscriber and the information about the status of the terminals, for each terminal. The terminal status monitoring unit is configured to monitor a capability of the terminal is possessed by the subscriber to receive the broadcasting service and notify the terminal related information storage unit of the capability. The terminal status related information sending unit is configured to send the service control server the information about the status of the terminal by communicating with the service control server. The subscriber related information sending unit is configured to send the terminal related information storage unit information about a subscription or a secession of the subscriber for the broadcasting service, by communicating with the broadcast server.

The service control server includes a terminal status related information receiving unit, a service control information managing unit, a terminal preference managing unit, and a service control determination unit. The terminal status related information receiving unit is configured to receive the information about the status of the terminal by communicating with the terminal managing server. The service control information managing unit is configured to store and manage control information for the broadcasting service that is provided to the subscriber. The terminal preference managing unit is configured to store and manage a degree of preference to a terminal preferred by the subscriber among the terminals when the subscriber receives the broadcasting service. The service control determination unit is configured to select the terminal suitable for receiving the broadcasting service by use of the information about the status of the terminal, the control information for the broadcasting service and the degree of preference to the each terminal and provide the selected terminal with the broadcasting service.

The information about the status of the terminal includes a type of each terminal possessed by the subscriber, an attribute of the each terminal and a capability of the each terminal to receive the broadcasting service.

The degree of preference to the each terminal corresponds to a frequency of use of the each terminal by date, time or a preset classification.

In another general aspect, there is provided a method for providing a broadcasting is service in a multi-terminal context in an IP based network. The method is as follows. Information about a status of each of a plurality of terminals possessed by a subscriber is acquired when the broadcasting service is to be provided to the terminal of the subscriber according to a channel selected by the subscriber or by a subscriber program log personalized for the subscriber. A degree of preference to a terminal desired by the subscriber among the terminals is acquired when the subscriber receives the broadcasting service. A terminal suitable for receiving the broadcasting service is selected by use of the information about the status of the each terminal and the degree of preference to the each terminal. The broadcasting service is provided to the selected terminal.

In this manner, when a subscriber possesses a plurality of terminals capable of receiving a service through wired/wireless access networks, a customized convergence broadcasting service can be provided to the subscriber according to the status of each terminal and the preference of the subscriber for each terminal.

The method for providing a broadcasting service in a multi-terminal context in an IP based network further includes re-acquiring information about a status of a predetermined terminal possessed by the subscriber if the information about the status of the predetermined terminal is changed while the broadcasting service is being provided to the predetermined terminal, re-acquiring a degree of preference to the predetermined terminal, re-selecting a terminal suitable for receiving the broadcasting service by use of the re-acquired information about the status of the predetermined terminal and the re-acquired degree of preference to the predetermined terminal, and providing the re-selected terminal with the broadcasting service.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an example of an IP network architecture for controlling a broadcasting service in a multi-terminal context.

FIG. 2 is a diagram illustrating an example of a system for controlling a multi-terminal context-based convergence broadcasting service.

FIG. 3 is a diagram illustrating an example of a broadcast server of the broadcasting service controlling system of FIG. 2.

FIG. 4 is a diagram illustrating an example of a terminal managing server of the broadcasting service controlling system of FIG. 2.

FIG. 5 is a diagram illustrating an example of a service control server of the broadcasting service controlling system of FIG. 2.

FIG. 6 is a diagram illustrating an example of information that is stored in a terminal related information storage unit of the terminal managing server and managed by a terminal preference managing unit of the service control server.

FIG. 7 is a flowchart illustrating an example of an operation of the service control server.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described with reference to accompanying drawings in detail.

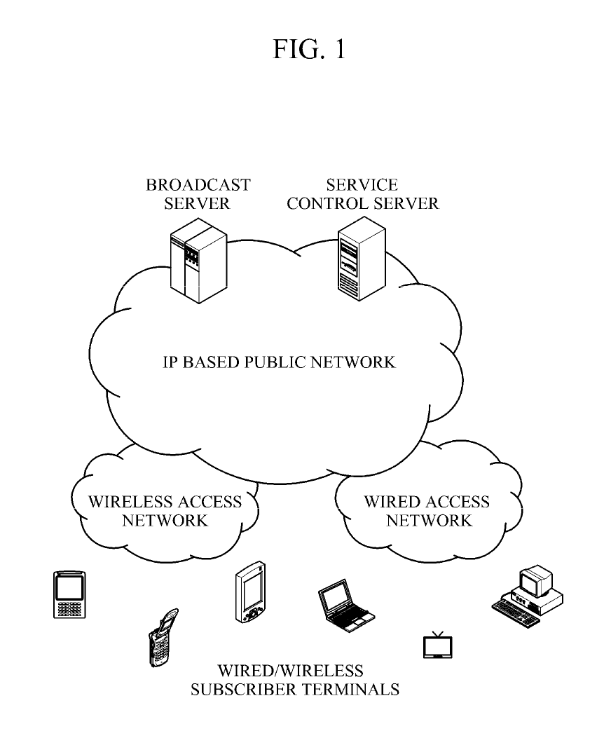

FIG. 1 is a diagram illustrating an example of an IP network architecture for controlling a broadcasting service in a multi-terminal context.

As shown in FIG. 1, the IP network architecture includes an IP based public network, wired/wireless access networks to which a subscriber terminal is connected to receive a service, a broadcast server for providing a customized convergence broadcasting service, a service control server for controlling a customized convergence broadcasting service and subscriber terminals for receiving the customized convergence broadcasting service through the broadcast server and the service control server.

The IP based public network is a network for supporting an IP communication and may include a Broadband convergence Network (BcN) as a representative example. The wired/wireless access networks also support an IP communication and an example of a wireless access network is a mobile IP network such as Long Term Evolution (LTE), a Wibro network and a Wireless LAN network and an example of a wired access network is a Passive Optical Network (PON), an optical LAN network and Xdsl networks.

Accordingly, the subscriber terminal may include various types of terminals, such as a mobile phone, a PDA, a smart phone, a note book computer, a net-book, a portable media player (PMP), a personal computer (PC), an IP set top box (STB), etc. that can access the wired/wireless access networks through the IP communication.

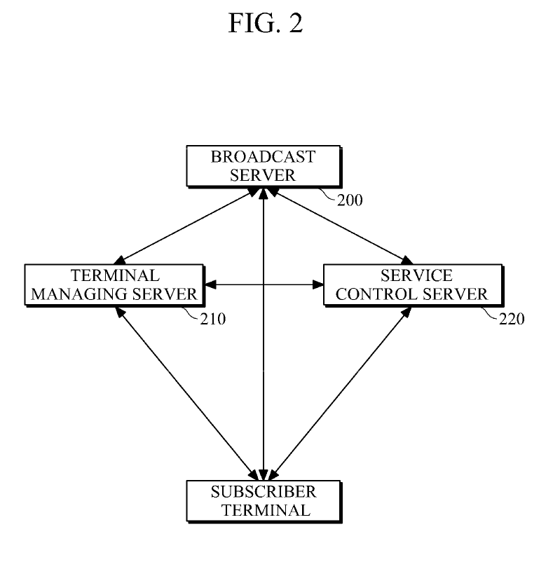

FIG. 2 is a diagram illustrating an example of a system for controlling a multi-terminal context-based convergence broadcasting service.

As shown in FIG. 2, the broadcasting service control system includes a broadcast server 200, a terminal managing server 210 and a service control server 220.

The broadcast server 200 provides a subscriber with a customized broadcasting service according to a channel selected by the subscriber or a subscriber program log organized by the subscriber.

The terminal managing server 210 is configured to monitor the status of various kinds of heterogeneous terminals used by the subscriber and manage status information of each terminal. The service control server 220 serves to control a customized convergence broadcasting service, which is provided to the subscriber based on the information about the status of the multiple terminals, information about a terminal preferred by the subscriber and service control information.

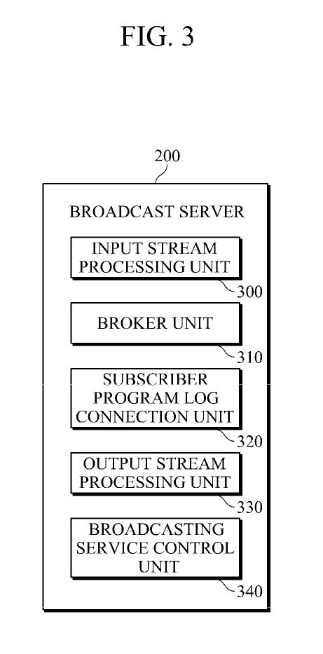

FIG. 3 is a diagram illustrating an example of a broadcast server of the broadcasting service controlling system of FIG. 2.

As shown in FIG. 3, the broadcast server 200 includes an input stream processing unit 300, a broker unit 310, a subscriber program log connection unit 320, an output stream processing unit 300 and a broadcasting service control unit 340.

The input stream processing unit 300 receives terrestrial/cable/satellite broadcast program, Video on Demand (VoD) contents or User Created Contents (UCC) that are created by a private user or low volume content producer from a content providing unit of a private user.

The broker unit 310 receives contents. The subscriber program log connection unit 320 is associated to a personal program log organized by a subscriber to control a broadcast program.

The output stream processing unit 300 provides a subscriber (a subscriber terminal) with a broadcast program.

As a subscriber organizes a personal channel, a stream is input through the input stream processing unit 300 by a preset time organized by the subscriber and input contents are connected to the output stream processing unit 330.

If the contents to be broadcasted are VoD contents, UCC contents and PCC contents other than terrestrial/cable/satellite broadcast programs, the broker unit 310 directly receives the contents and provides a broadcast program to a subscriber.

The broadcasting service control unit 340 interworks with the service control server that controls a customized broadcasting service according to the status of each terminal in an environment where a subscriber possesses a plurality of heterogeneous terminals.

In controlling a service of the broadcast server 200 according to the determination of the service control server 220, the broadcasting service control unit 340 controls a customized broadcasting service in cooperation with other components forming the broadcast server 200 by receiving a request for controlling from the service control server 220 and transmits a result of the controlling to the service control server 220.

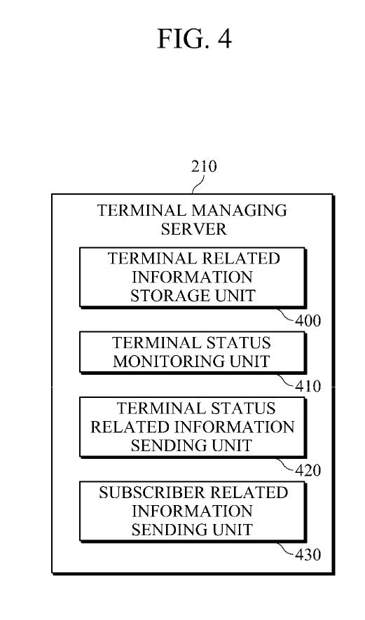

FIG. 4 is a diagram illustrating an example of a terminal managing server of the broadcasting service controlling system of FIG. 2.

As shown in FIG. 4, the terminal managing server 210 includes a terminal related information storage unit 400, a terminal status monitoring unit 410, a terminal status related information sending unit 420 and a subscriber related information sending unit 430.

The terminal related information storage unit 400 stores and manages information about a plurality of heterogeneous terminals possessed by a subscriber. In detail, the terminal related information storage unit 400 stores information about the status of each terminal.

The terminal status monitoring unit 410 monitors the status of terminals possessed by a subscriber, that is, a capability of each terminal to receive a service and transmits status information about each terminal to the terminal related information storage unit 400.

While communicating with the service control server 220, the terminal status related information sending unit 420 transmits the information about the status of the corresponding subscriber terminal according to the request of the service control server 220 or notifies the change of status of the subscriber terminal, being monitored.

The subscriber related information sending unit 430 receives information about subscription or secession of a subscriber for a customized convergence broadcasting service and transmits the information about subscription or secession to the terminal related information storage unit 400 which stores information about the corresponding subscriber terminal.

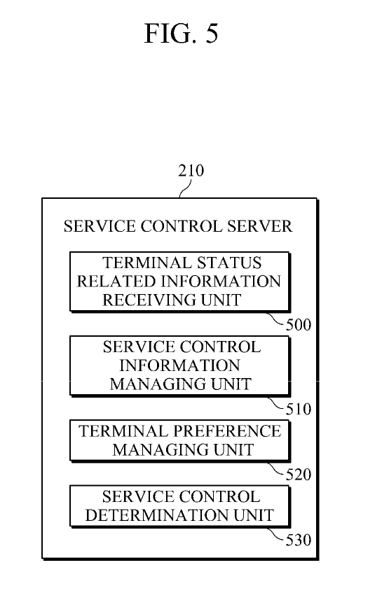

FIG. 5 is a diagram illustrating an example of a service control server of the broadcasting service controlling system of FIG. 2.

As shown in FIG. 5, the service control server 200 includes a terminal status related information receiving unit 500, a service control information managing unit 510, a terminal preference managing unit 520, and a service control determination unit 530.

The terminal status related information receiving unit 500 provides an association function to exchange the information about the status of each subscriber terminal that is managed by the terminal managing server 210.

The service control information managing unit 510 stores and manages information concerning the status of services that are provided to a subscriber. The terminal preference managing unit 520 stores and manages information concerning the degree of preference of a subscriber for a plurality of terminals that are possessed by the subscriber when the subscriber receives a customized convergence broadcasting service.

The service control determination unit 530 makes a determination for a service control according to the status information about each subscriber terminal and the information concerning the preference degree of a subscriber for each subscriber terminal, and transfers service control information to the broadcast server 200.

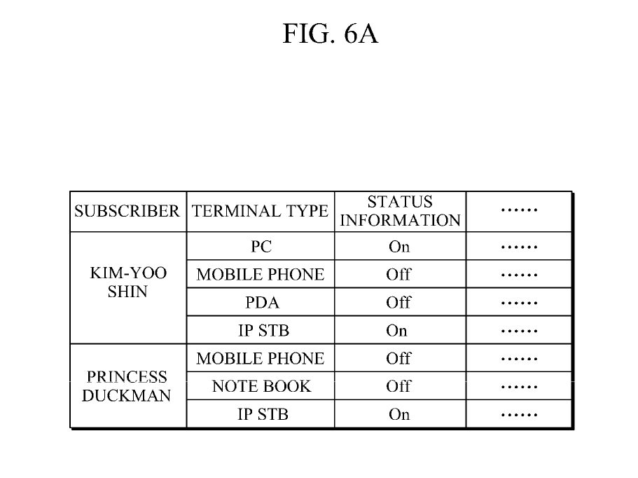

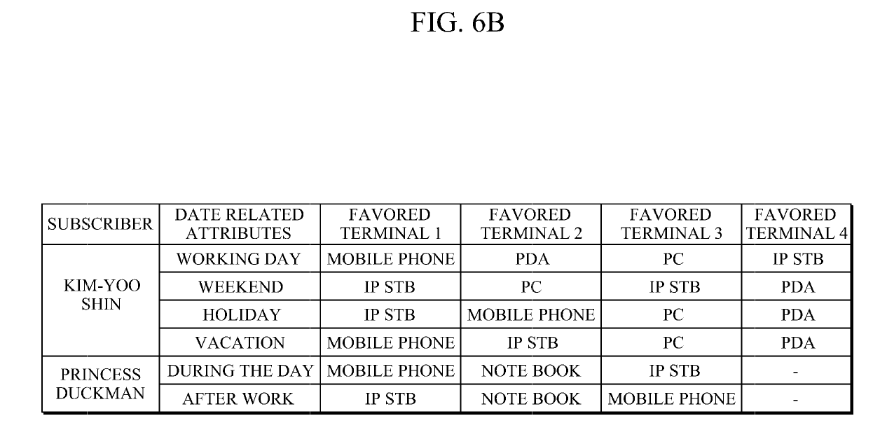

FIG. 6 is a diagram illustrating an example of information that is stored and managed by a terminal related information storage unit of the terminal managing server and by a terminal preference managing unit of the service control server.

FIG. 6A illustrates information that is stored and managed by the terminal related information storage unit 400 of the terminal managing server 210. The terminal related information storage unit 400 of the terminal managing server 210 stores information about the types, attributes and current statuses of respective terminals possessed by a subscriber. In detail, the status information about each terminal may vary at any time depending on information collected by the terminal status monitoring unit 410.

FIG. 6B illustrates information that is stored and managed by the terminal preference managing unit 520 of the service control server 220. When a subscriber receives a customized convergence broadcasting service, the terminal preference managing unit 520 of the service control server 220 stores and manages information concerning the degree of preference of each terminal according to date related attributes, such as a working day, a holiday and a vacation or according to another classification, for example, during the day and after work.

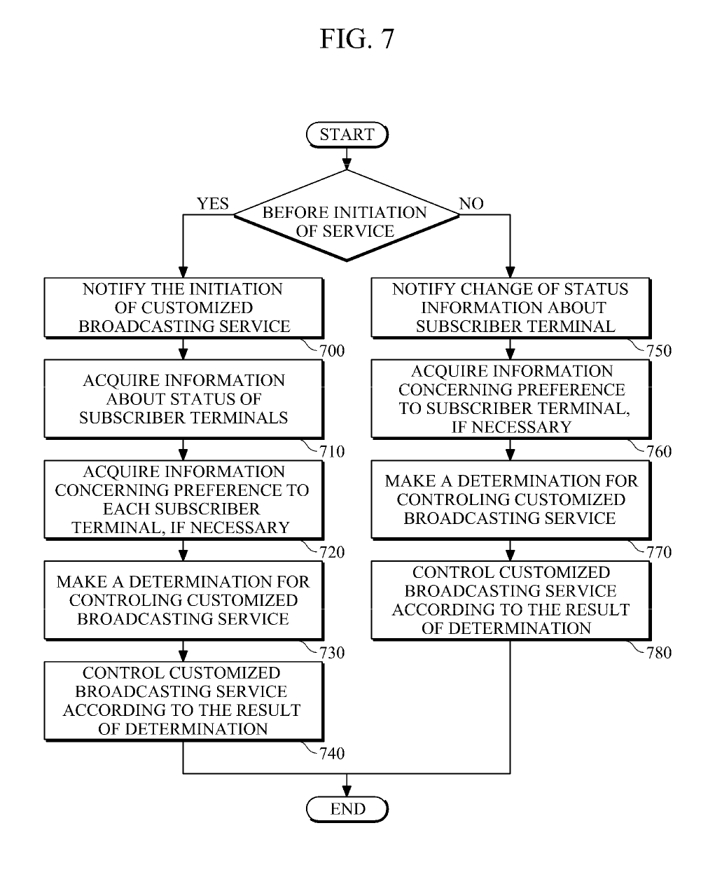

FIG. 7 is a flowchart illustrating an example of an operation of the service control server.

The service control server 220 serving to control a customized convergence broadcasting service operates differently depending on before and after initiation of the customized convergence broadcasting service.

Before the initiation of the service, the service control server 200 receives a notification of the initiation of the customized convergence broadcasting service for each subscriber from a broadcast server (700).

Upon reception of the notification, the service control server 220 transmits information about the corresponding subscriber to the terminal managing server 210 and acquires information about the status of an available terminal of the subscriber (710).

If the corresponding subscriber has two available terminals, the service control server 220 acquires information concerning the preference degree of the subscriber to the two terminals through the terminal preference managing unit 520 (720), and makes a determination for controlling a customized broadcasting service based on the information concerning the preference degree to the terminals (730). After that, the service control server 220 controls the broadcast server 200 according to the result of determination (740).

After the initiation of the service, if the status of a subscriber terminal is changed, the terminal managing server 210, having detected the change, notifies the service control server 220 of the changed status of the corresponding subscriber terminal (750).

If necessary, the service control server 220 acquires information concerning the preference degree of the subscriber to the terminals through the terminal preference managing unit 520 (760), and makes a determination for controlling a customized broadcasting service based on the information concerning the preference degree to the terminals (770). After that, the service control server 220 controls the broadcast server 200 according to the result of determination (780).

Table 1 illustrates standards for determining the customized convergence broadcasting service control, a method for determining the service control and the measures to be taken according to the determination.

TABLE

| | | | Preference | | |
|---|---|---|---|---|---|
| | | Context of | Information to | Service | Determination |
| | | subscriber | Service | Control | and Measures |
| Case | | terminals | Terminal | Information | Taken |
| Before | 1 | No available | | No Service | Sending the |
| Initiation of | | terminal | | | broadcast |
| Service | | | | | server a request |
| | | | | | for recording |
| | | | | | broadcast |
| | | | | | program |
| | 2 | One available | | On Service | Requesting |
| | | terminal | | | broadcast |
| | | | | | server to |
| | | | | | provide a |
| | | | | | corresponding |
| | | | | | available |
| | | | | | terminal with |
| | | | | | service |
| | 3 | Two or more | Preference to | On Service | After checking |
| | | available terminals | service terminal | | the service |
| | | | | | preference to |
| | | | | | the available |
| | | | | | terminal, |
| | | | | | requesting the |
| | | | | | broadcast |
| | | | | | server to |
| | | | | | provide a |
| | | | | | corresponding |
| | | | | | available |
| | | | | | terminal with |
| | | | | | service |
| After | 4 | No available | | No Service > | Upon finding |
| Initiation of | | terminal > When | | On Service | an available |
| Service | | One available | | | terminal, |
| | | terminal is found | | | requesting the |
| | | | | | broadcast |
| | | | | | server to |
| | | | | | provide the |
| | | | | | corresponding |
| | | | | | available |
| | | | | | terminal with |
| | | | | | service and to |
| | | | | | stop recording |
| | 5 | No available | Preference to | No Service > | After checking |
| | | terminal > Two or | service terminal | On Service | the service |
| | | more available | | | preference of |
| | | terminals are found | | | the available |
| | | | | | terminal, upon |
| | | | | | finding an |
| | | | | | available |
| | | | | | terminal, |
| | | | | | requesting the |
| | | | | | broadcast |
| | | | | | server to |
| | | | | | provide the |
| | | | | | corresponding |
| | | | | | available |
| | | | | | terminal with |
| | | | | | service |
| | 6 | While providing | | On service > | Upon detecting |
| | | service, detecting | | No service | the Absence of |
| | | the absence of | | | available |
| | | available terminal | | | terminal, |
| | | | | | requesting the |
| | | | | | broadcast |
| | | | | | server to stop |
| | | | | | providing |
| | | | | | service and to |
| | | | | | record a |
| | | | | | following |
| | | | | | broadcast |
| | | | | | program |
| | 7 | While providing | Preference to | On service | After checking |
| | | service, finding | service terminal | | the service |
| | | New available | | | preference to |
| | | terminal | | | the available |
| | | | | | terminal, if the |
| | | | | | preference to |
| | | | | | the newly |
| | | | | | found available |
| | | | | | terminal is |
| | | | | | high, requesting |
| | | | | | the broadcast |
| | | | | | server to |
| | | | | | provide the new |
| | | | | | terminal with |
| | | | | | service |
| | 8 | While providing | | On service | Requesting the |
| | | service > | | | broadcast |
| | | Unavailable | | | server to |
| | | terminal is found > | | | provide the |
| | | One available | | | corresponding |
| | | terminal remains | | | available |
| | | | | | terminal with |
| | | | | | service |
| | 9 | While providing | Preference to | On service | After checking |
| | | service > | service terminal | | the service |
| | | Unavailable | | | preference to |
| | | terminal is | | | the available |
| | | found > One or more | | | terminals, |
| | | available terminals | | | requesting the |
| | | remain | | | broadcast |
| | | | | | server to |
| | | | | | provide a |
| | | | | | corresponding |
| | | | | | available |
| | | | | | terminal with |
| | | | | | service |

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for providing a broadcasting service in a multi-terminal context in an IP based network, the system comprising:
a broadcast server configured to provide a broadcasting service to a terminal of a subscriber according to a channel selected by the subscriber or by a subscriber program log personalized for the subscriber;
a terminal managing server configured to monitor each status of a plurality of terminals possessed by the subscriber and manage information about the status of each terminal; and
a service control server configured to select a terminal suitable for receiving the broadcasting service by use of the information about the status of the each terminal and provide the selected terminal with the broadcasting service.

2. The system of claim 1, wherein the broadcast server further comprises a broadcasting service control unit configured to perform control such that the broadcast service is provided to the terminal selected by the service control server by communicating with the service control server.

3. The system of claim 1, wherein the terminal managing server comprises:
a terminal related information storage unit configured to store and manage information about the terminals possessed by the subscriber and the information about the status of the terminals, for each terminal;
a terminal status monitoring unit configured to monitor a capability of the terminal possessed by the subscriber to receive the broadcasting service and notify the terminal related information storage unit of the capability;
a terminal status related information sending unit configured to send the service control server the information about the status of the terminal by communicating with the service control server; and
a subscriber related information sending unit configured to send the terminal related information storage unit information about a subscription or a secession of the subscriber for the broadcasting service, by communicating with the broadcast server.

4. The system of claim 1, wherein the service control server comprises:
a terminal status related information receiving unit configured to receive the information about the status of the terminal by communicating with the terminal managing server;
a service control information managing unit configured to store and manage control information for the broadcasting service that is provided to the subscriber;
a terminal preference managing unit configured to store and manage a degree of preference to a terminal preferred by the subscriber among the terminals when the subscriber receives the broadcasting service; and
a service control determination unit configured to select the terminal suitable for receiving the broadcasting service by use of the information about the status of the terminal, the control information for the broadcasting service and the degree of preference to the each terminal and provide the selected terminal with the broadcasting service.

5. The system of claim 5, wherein the information about the status of the terminal includes a type of each terminal possessed by the subscriber, an attribute of the each terminal and a capability of the each terminal to receive the broadcasting service.

6. The system of claim 4, wherein the degree of preference to the each terminal corresponds to a frequency of use of the each terminal by date, time or a preset classification.

7. A method for providing a broadcasting service in a multi-terminal context in an IP based network, the method comprising:
acquiring information about a status of each of a plurality of terminals possessed by a subscriber when the broadcasting service is to be provided to the terminal of the subscriber according to a channel selected by the subscriber or by a subscriber program log personalized for the subscriber;
acquiring a degree of preference to a terminal desired by the subscriber among the terminals when the subscriber receives the broadcasting service;
selecting a terminal suitable for receiving the broadcasting service by use of the information about the status of the each terminal and the degree of preference to the each is terminal; and
providing the selected terminal with the broadcasting service.

8. The method of claim 7, further comprising:
re-acquiring information about a status of a predetermined terminal possessed by the subscriber if the information about the status of the predetermined terminal is changed while the broadcasting service is being provided to the predetermined terminal;
re-acquiring a degree of preference to the predetermined terminal;
re-selecting a terminal suitable for receiving the broadcasting service by use of the re-acquired information about the status of the predetermined terminal and the re-acquired degree of preference to the predetermined terminal; and
providing the re-selected terminal with the broadcasting service.
